(19) United States
(12) Patent Application Publication
(10) Pub. No.: US 2024/0077718 A1
(43) Pub. Date: Mar. 7, 2024

(54) SCANNING OPTICAL DEVICE

(71) Applicant: BROTHER KOGYO KABUSHIKI KAISHA, Nagoya (JP)

(72) Inventor: Junichi YOKOI, Nagoya (JP)

(21) Appl. No.: 18/457,438

(22) Filed: Aug. 29, 2023

(30) Foreign Application Priority Data
Sep. 5, 2022 (JP) 2022-140800

(51) Int. Cl. G02B 26/12; G02B 7/182; G02B 27/00

(52) U.S. Cl. CPC G02B 26/121; G02B 7/1821; G02B 26/124; G02B 27/0006

(57) ABSTRACT

A scanning optical system receives a light beam deflected by an optical deflector and forms an image on an image surface. A window member transmits the light beam deflected by the optical deflector. An optical sensor detects the light beam that passes through the window member. A frame has a mount surface on which the optical deflector is mounted. The frame includes a first wall having a first opening and a second opening. The light beam directed from the optical deflector toward the scanning optical system passes through the first opening. The light beam directed from the optical deflector toward the optical sensor passes through the second opening. The first opening is closed by a closest scanning lens to the optical deflector in the scanning optical system. The second opening is closed by the window member.

### REFERENCE TO RELATED APPLICATIONS

This application claims priority from Japanese Patent Application No. 2022-140800 filed on Sep. 5, 2022. The entire content of the priority application is incorporated herein by reference.

### BACKGROUND ART

A scanning optical device including a polygon mirror is known.

### DESCRIPTION

A polygon mirror may be damaged by dust and so on contained in the surrounding air hitting the rotating mirror, and reflectance may decrease. It is considered that a scanning optical device has a seal that prevents dust from entering around the polygon mirror. In this technique, a scanning lens seals a hole formed in a wall arranged on the output side of the polygon mirror.

In the above technique, a light beam directed to an optical sensor for detecting the light beam passes through the scanning lens. Thus, the scanning lens need to have a region for passing the light beam directed to the optical sensor, which may increase the size of the scanning lens.

In view of the foregoing, an example of an object of this disclosure is to suppress dust and so on entering around a polygon mirror while suppressing an increase in the size of a scanning lens.

According to one aspect, this specification discloses a scanning optical device. The scanning optical device includes a semiconductor laser, a coupling lens, an optical deflector, a scanning optical system, a window member, an optical sensor, and a frame. The semiconductor laser is configured to emit light. The coupling lens is configured to convert the light emitted by the semiconductor laser into a light beam. The optical deflector includes a polygon mirror configured to deflect, in a main scanning direction, the light beam converted by the coupling lens. The scanning optical system is configured to receive the light beam deflected by the optical deflector and to form an image on an image surface. The window member is configured to transmit the light beam deflected by the optical deflector. The optical sensor is configured to detect the light beam that passes through the window member. The frame has a mount surface on which the optical deflector is mounted. The frame includes a first wall having a first opening and a second opening. The light beam directed from the optical deflector toward the scanning optical system passes through the first opening. The light beam directed from the optical deflector toward the optical sensor passes through the second opening. The first opening is closed by a closest scanning lens to the optical deflector in the scanning optical system. Thus, the scanning lens suppresses dust and so on entering around the polygon mirror through the first opening. The second opening is closed by the window member. Thus, the window member suppresses dust and so on entering around the polygon mirror through the second opening. Further, since the light beam directed toward the optical sensor passes through the window member different from the scanning lens, it is unnecessary to provide the scanning lens with an area for allowing the light beam directed toward the optical sensor to pass through. This suppresses an increase in the size of the scanning lens.

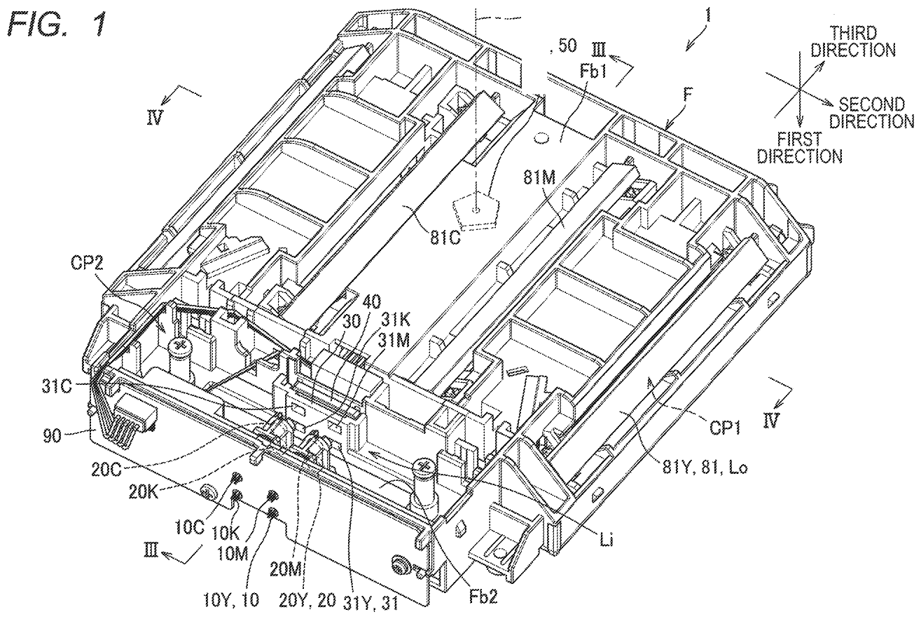

FIG. 1 is a perspective view of a scanning optical device viewed from an other side in a first direction.

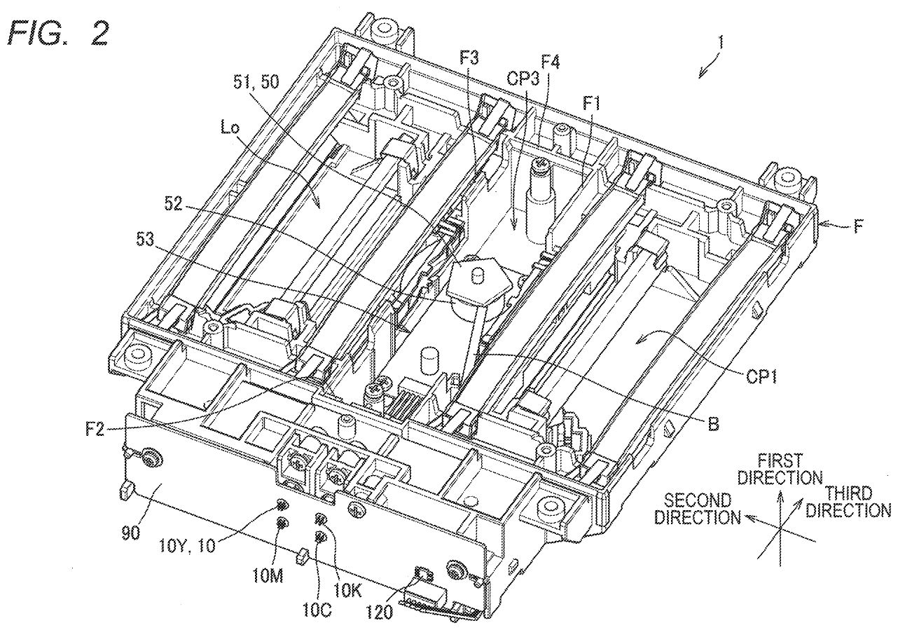

FIG. 2 is a perspective view of the scanning optical device viewed from one side in the first direction.

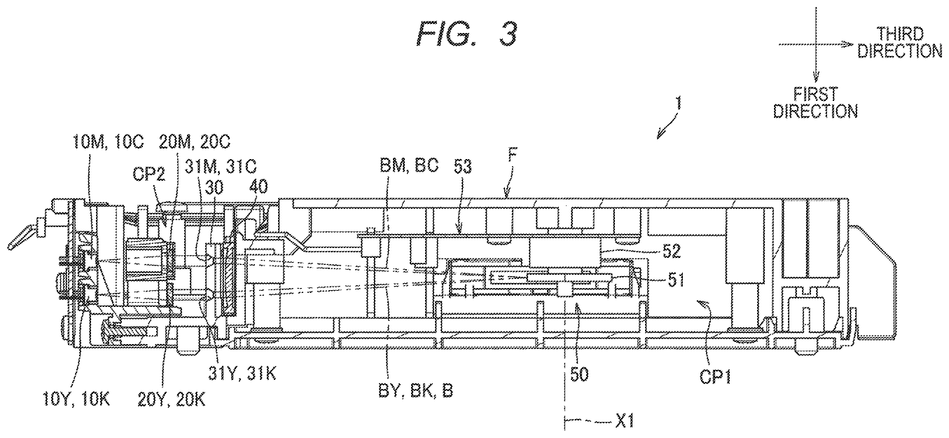

FIG. 3 is a cross-sectional view taken along a line in FIG. 1.

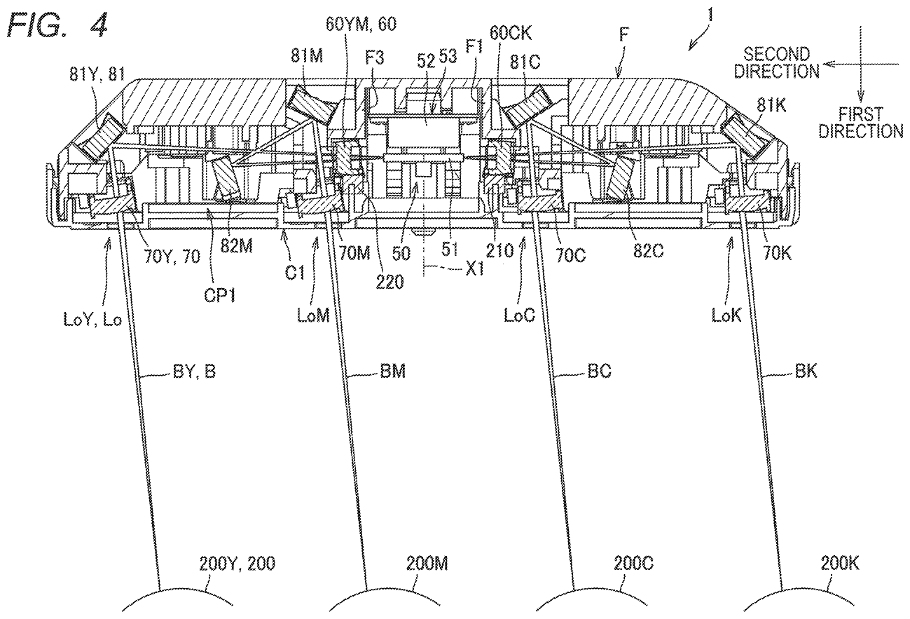

FIG. 4 is a cross-sectional view taken along a line IV-IV in FIG. 1.

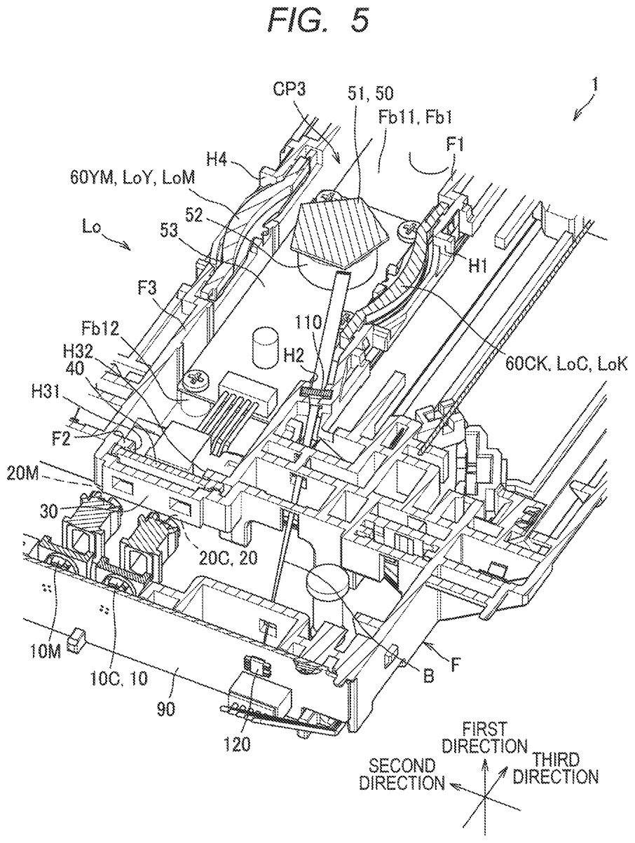

FIG. 5 is an enlarged perspective view showing a structure around an optical deflector of the scanning optical device cut along a plane perpendicular to the first direction and passing through a window member.

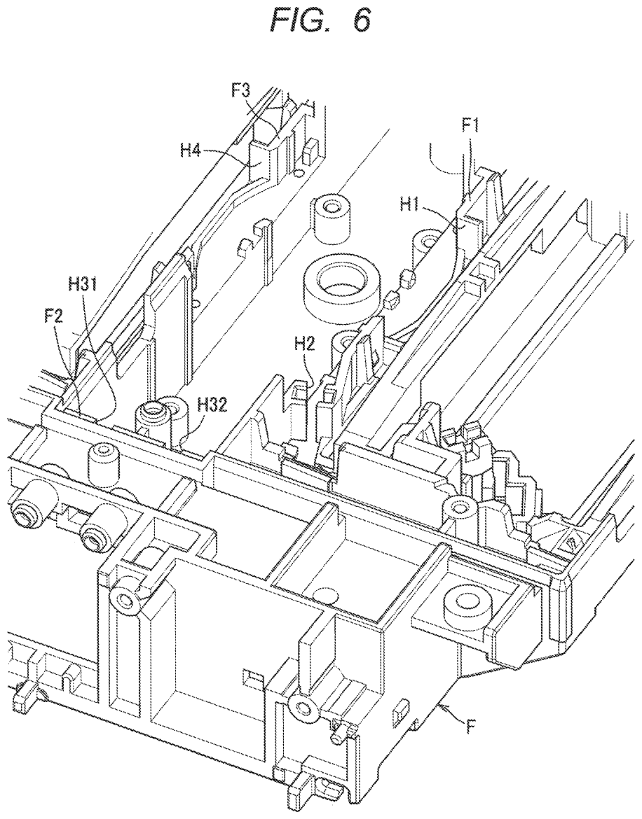

FIG. 6 is an enlarged perspective view showing a structure around a first wall of a frame.

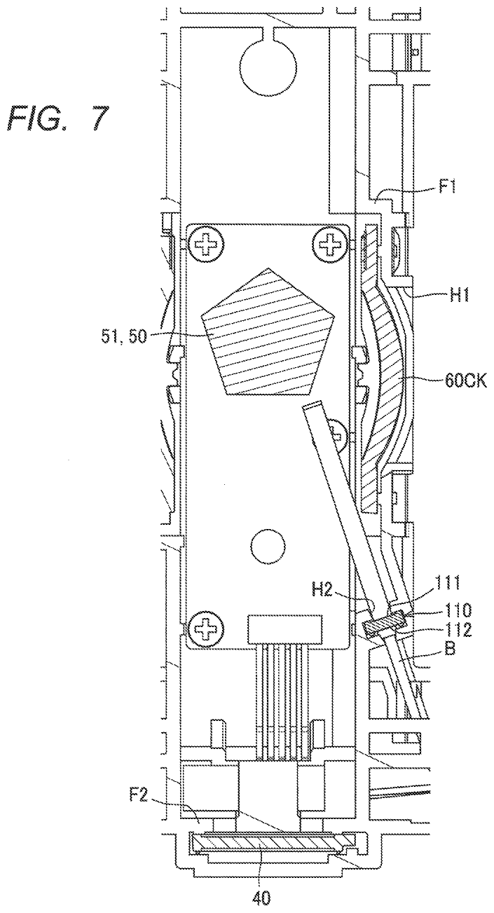

FIG. 7 is a cross-sectional view showing a structure around the optical deflector of the scanning optical device taken along a plane perpendicular to the first direction and passing through the window member.

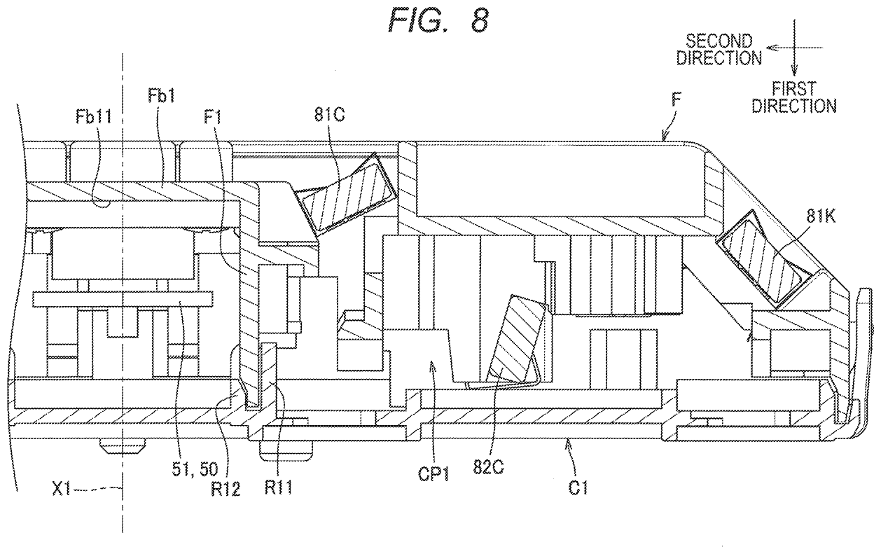

FIG. 8 is a cross-sectional view showing a relationship between the first wall and a first cover.

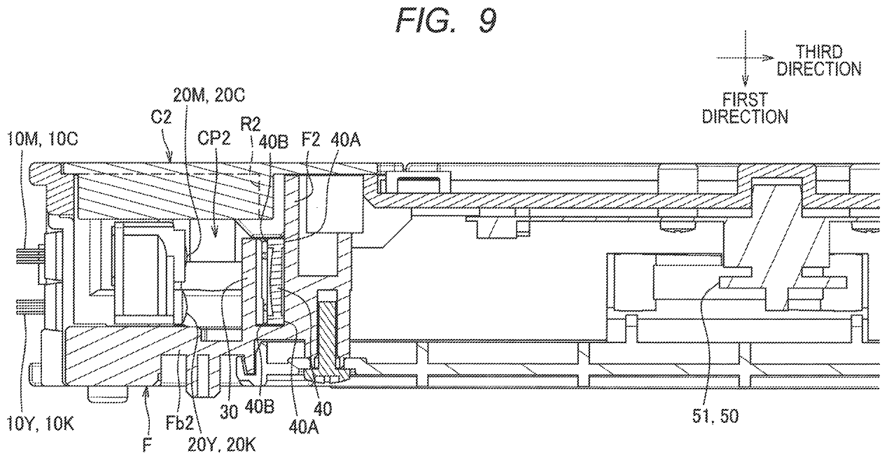

FIG. 9 is a cross-sectional view showing a relationship between a second wall and a second cover.

As shown in FIGS. 1 and 2, a scanning optical device 1 includes a frame F, an incident optical system Li, an optical deflector 50, and a scanning optical system Lo. In this embodiment, the scanning optical device 1 is applied to an electrophotographic image forming apparatus. The image forming apparatus includes four photosensitive drums 200 (see FIG. 4).

In the following description, a direction parallel to a rotation axis X1 of a polygon mirror 51 described later is referred to as a “first direction”. A direction perpendicular to the first direction and in which the polygon mirror 51 and a first scanning lens 60 (see FIG. 4) are arranged is referred to as a “second direction”. A direction perpendicular to the first direction and the second direction is referred to as a “third direction”. The third direction corresponds to a main scanning direction, and the first direction corresponds to a sub-scanning direction of the incident optical system Li. It is assumed that an arrow showing each direction in drawings indicates one side in each direction.

The incident optical system Li includes four semiconductor lasers 10, four coupling lenses 20, an aperture plate 30, and a condenser lens 40.

The semiconductor lasers 10 are devices that emit light. Four semiconductor lasers 10 are provided corresponding to the four photosensitive drums 200 (see FIG. 4) that are scanned and exposed by the scanning optical device 1. Toner images of different colors are formed on the photosensitive drums 200.

In this embodiment, a first color is “yellow (Y)”, a second color is “magenta (M)”, a third color is “cyan (C)”, and a fourth color is “black (K)”. In the following description, the name of the part corresponding to the first color may be prefixed with “first” and the part corresponding to the first color may be distinguished by adding “Y” to the end of the reference numeral. Similarly, the parts corresponding to the second, third, and fourth colors are prefixed with “second,” “third,” and “fourth,” and suffixed with “M, “C”, and “K” may be used for distinguishing.

The semiconductor lasers 10 include a first semiconductor laser 10Y corresponding to yellow, a second semiconductor laser 10M corresponding to magenta, a third semiconductor laser 10C corresponding to cyan, and a fourth semiconductor laser 10K corresponding to black. The first semiconductor laser 10Y is arranged with an interval in the first direction from the second semiconductor laser 10M. The first semiconductor laser 10Y is located on one side in the first direction with respect to the second semiconductor laser 10M.

The third semiconductor laser 10C is arranged with an interval in the second direction from the second semiconductor laser 10M. The third semiconductor laser 10C is located on the other side in the second direction with respect to the second semiconductor laser 10M. The fourth semiconductor laser 10K is arranged with an interval in the first direction from the third semiconductor laser 10C, and is arranged with an interval in the second direction from the first semiconductor laser 10y.

The coupling lens 20 is a lens that converts light from the semiconductor laser 10 into a light beam. The coupling lenses 20Y, 20M, 20C and 20K for respective colors are arranged at positions facing corresponding semiconductor lasers 10Y, 10M, 10C and 10K.

The aperture plate 30 has stop apertures 31 through which the light beam from the coupling lens 20 passes. In this embodiment, the aperture plate 30 is formed integrally with the frame F. The aperture plate 30 is located between the coupling lens 20 and the condenser lens 40. Four stop apertures 31 are provided corresponding to the four semiconductor lasers 10 and coupling lenses 20.

The condenser lens 40 is a lens that condenses the light beam from the coupling lens 20 onto a mirror surface of the polygon mirror 51 in the sub-scanning direction. The condenser lens 40 is located on the side opposite to the coupling lens 20 with respect to the aperture plate 30.

As shown in FIG. 3, the optical deflector 50 is a device that deflects the light beam from the coupling lens 20 in the main scanning direction (third direction), and includes the polygon mirror 51, a motor 52, and a motor circuit board 53. The polygon mirror 51 rotates to deflect the light beam in the main scanning direction. The polygon mirror 51 has five mirror surfaces provided at equal distances from the rotation axis X1 (see also FIG. 1). The motor 52 is a motor for rotating the polygon mirror 51. The motor circuit board 53 is provided with the motor 52. The motor circuit board 53 is fixed to the frame F.

As shown in FIG. 4, the scanning optical system Lo is an optical system that forms an image of the light beam deflected by the optical deflector 50 on the surface of the photosensitive drum 200 serving as an image surface. Each component constituting the scanning optical system Lo is fixed to the frame F. The scanning optical system Lo includes a first scanning optical system LoY corresponding to yellow, a second scanning optical system LoM corresponding to magenta, a third scanning optical system LoC corresponding to cyan, and a fourth scanning optical system LoK corresponding to black.

The first scanning optical system LoY and the second scanning optical system LoM are arranged on one side of the polygon mirror 51 in the second direction. The third scanning optical system LoC and the fourth scanning optical system LoK are arranged on the other side of the polygon mirror 51 in the second direction. A light beam from the optical deflector 50 is incident on each of the scanning optical systems LoY, LoM, LoC, and LoK.

The first scanning optical system LoY includes a first scanning lens 60YM, a second scanning lens 70Y, and a reflecting mirror 81Y. The first scanning lens 60YM is the closest optical component to the optical deflector 50 among the optical components that constitute the first scanning optical system LoY. Specifically, with respect to the distance along the optical path of the light beam passing through the center in the main scanning direction in the first scanning optical system LoY, the first scanning lens 60YM is the closest optical component to the optical deflector 50.

The first scanning lens 60YM is a lens that refracts light beams BY and BM deflected by the optical deflector 50 in the main scanning direction and forms images on the photosensitive drums 200Y and 200M. The first scanning lens 60YM has an fθ characteristic that causes the light beams BY and BM scanned at a constant angular velocity by the optical deflector 50 to have a constant velocity on the photosensitive drums 200Y and 200M.

The reflecting mirror 81Y is a mirror that reflects the light beam BY from the first scanning lens 60YM toward the photosensitive drum 200Y.

The second scanning lens 70Y is a lens that refracts the light beam BY reflected by the reflecting mirror 81Y in the sub-scanning direction and forms an image on the photosensitive drum 200Y. In the scanning optical system Lo, the sub-scanning direction corresponds to the direction perpendicular to the main scanning direction and a light beam traveling direction. The second scanning lens 70Y is arranged on one side of the polygon mirror 51 in the first direction.

The second scanning optical system LoM includes the first scanning lens 60YM, a second scanning lens 70M, a reflecting mirror 81M, and a mirror 82M. The first scanning lens 60YM is the closest optical component to the optical deflector 50 among the optical components that constitute the second scanning optical system LoM.

The first scanning lens 60YM is shared with the first scanning optical system LoY. The mirror 82M is a mirror that reflects the light beam BM from the first scanning lens 60YM to the reflecting mirror 81M. The second scanning lens 70M and the reflecting mirror 81M have similar functions to the second scanning lens 70Y and the reflecting mirror 81Y of the first scanning optical system LoY. That is, the reflecting mirror 81M reflects the light beam BM reflected by the mirror 82M toward the photosensitive drum 200M, and the second scanning lens 70M refracts the light beam BM reflected by the reflecting mirror 81M in the sub-scanning direction and forms an image on the photosensitive drum 200M.

The third scanning optical system LoC has a structure that is substantially symmetrical with the second scanning optical system LoM with respect to the rotation axis X1 of the polygon mirror 51. Specifically, the third scanning optical system LoC includes a first scanning lens 60CK, a second scanning lens 70C, a reflecting mirror 81C, and a mirror 82C that have functions similar to the members of the second scanning optical system LoM. The first scanning lens 60CK is the closest optical component to the optical deflector 50 among the optical components that constitute the third scanning optical system LoC.

The first scanning lens 60CK refracts light beams BC and BK deflected by the optical deflector 50 in the main scanning direction to form images on the photosensitive drums 200C and 200K. The mirror 82C reflects the light beam BC from the first scanning lens 60CK to the reflecting mirror 81C. The reflecting mirror 81C reflects the light beam BC reflected by the mirror 82C toward the photosensitive drum 200C. The second scanning lens 70C refracts the light beam BC reflected by the reflecting mirror 81C in the sub-scanning direction to form an image on the photosensitive drum 200C.

The fourth scanning optical system LoK has a structure that is substantially symmetrical with the first scanning optical system LoY with respect to the rotation axis X1 of the polygon mirror 51. Specifically, the fourth scanning optical system LoK includes the first scanning lens 60CK, a second scanning lens 70K, and a reflecting mirror 81K that have functions similar to the members of the first scanning optical system LoY. The first scanning lens 60CK is the closest optical component to the optical deflector 50 among the optical components that constitute the fourth scanning optical system LoK.

The reflecting mirror 81K reflects a light beam BK from the first scanning lens 60CK toward the photosensitive drum 200K. The second scanning lens 70K refracts the light beam BK reflected by the reflecting mirror 81K in the sub-scanning direction to form an image on the photosensitive drum 200K.

As shown in FIG. 3, the light emitted from each of the semiconductor lasers 10Y, 10M, 10C and 10K passes through the corresponding coupling lenses 20Y, 20M, 20C and 20K to be converted into light beams BY, BM, BC and BK. The light beams BY, BM, BC, and BK pass through the corresponding stop apertures 31Y, 31M, 31C and 31K of the aperture plate 30, pass through the condenser lens 40, and are incident on the polygon mirror 51. The condenser lens 40 is a lens through which all of the light beams BY, BM, BC, and BK pass, and has a cylindrical entrance surface and a flat exit surface.

As shown in FIG. 4, the polygon mirror 51 deflects the light beams BY, BM, BC and BK toward the corresponding scanning optical systems LoY, LoM, LoC and LoK. The light beam BY directed toward the first scanning optical system LoY passes through the first scanning lens 60YM, is reflected by the reflecting mirror 81Y, passes through the second scanning lens 70Y, and is emitted toward the photosensitive drum 200Y on one side in the first direction. The light beam BY is emitted from the second scanning lens 70Y at a particular angle with respect to the first direction. The light beam BY is imaged on the surface of the first photosensitive drum 200Y and is scanned in the main scanning direction.

The light beam BM directed toward the second scanning optical system LoM passes through the first scanning lens 60YM, is reflected by the mirror 82M and the reflecting mirror 81M, passes through the second scanning lens 70M, and is emitted toward the photosensitive drum 200M on one side in the first direction. The light beam BM is emitted from the second scanning lens 70M at a particular angle with respect to the first direction. The light beam BM is imaged on the surface of the second photosensitive drum 200M and is scanned in the main scanning direction. The light beams BC and BK are similarly emitted toward the photosensitive drums 200C and 200K on one side in the first direction by the corresponding scanning optical systems LoC and LoK, and are imaged on the surfaces of the corresponding photosensitive drums 200C and 200K and are scanned in the main scanning direction.

The frame F is made of resin and integrally formed by molding. The frame F has a first recess CP1 shown in FIG. 2 and a second recess CP2 shown in FIG. 1. The first recess CP1 opens on one side in the first direction. The second recess CP2 opens on the other side in the first direction. As shown in FIG. 4, the optical deflector 50 and part of the scanning optical system Lo are arranged in the first recess CP1. Specifically, the members of the scanning optical system Lo other than the reflecting mirrors 81 are arranged in the first recess CP1. As shown in FIG. 1, the coupling lens 20, the aperture plate 30, and the condenser lens 40 are arranged inside the second recess CP2. The second recess CP2 is arranged on the other side in the third direction with respect to the first recess CP1.

The frame F includes a first base wall Fb1 located at the bottom of the first recess CP1 and a second base wall Fb2 located at the bottom of the second recess CP2.

The first base wall Fb1 and the second base wall Fb2 are walls that cross the first direction. Specifically, the first base wall Fb1 and the second base wall Fb2 are walls whose thickness direction is along the first direction. That is, the first base wall Fb1 and the second base wall Fb2 are walls having flat surfaces perpendicular to the first direction.

The second base wall Fb2 is located at a position shifted to one side in the first direction with respect to the first base wall Fb1. As shown in FIG. 5, the optical deflector 50 is attached to the first base wall Fb1. Specifically, the motor circuit board 53 is fixed to the first base wall Fb1 with screws from one side in the first direction. Part of the scanning optical system Lo, more specifically, the members of the scanning optical system Lo excluding the reflecting mirrors 81 are attached to the first base wall Fb1 on one side in the first direction. The optical deflector 50 and part of the scanning optical system Lo are located on one side in the first direction with respect to the first base wall Fb1. As shown in FIG. 1, the semiconductor laser 10, the coupling lens 20, and the aperture plate 30 are located on the other side in the first direction with respect to the second base wall Fb2. The condenser lens 40 and the reflecting mirrors 81 are also located on the other side in the first direction with respect to second base wall Fb2.

The reflecting mirrors 81 are arranged near the first base wall Fb1 and are exposed on the other side in the first direction with respect to the first base wall Fb1. In other words, the first base wall Fb1 does not have a portion located on the other side of the reflecting mirrors 81 in the first direction. With this configuration, the reflecting mirrors 81 are exposed on the other side in the first direction without being hidden by the first base wall Fb1, and are attachable to the frame F from the other side in the first direction.

As shown in FIG. 5, the frame F has a mount surface Fb11 on which the optical deflector 50 is mounted. The motor circuit board 53 of the optical deflector 50 is fixed to a boss Fb12 protruding from the mount surface Fb11.

The scanning optical device 1 further includes a window member 110, an optical sensor 120, and a laser circuit board 90. The window member 110 is a member that transmits a light beam B deflected by the optical deflector 50. In this embodiment, the window member 110 is a lens that converges the light beam B onto the optical sensor 120.

As shown in FIG. 7, the window member 110 has a flat-shaped entrance surface 111. The entrance surface 111 is perpendicular to an optical path of the light beam B directed from the optical deflector 50 toward the optical sensor 120. The window member 110 has an exit surface 112 that converges light in the main scanning direction and the sub-scanning direction. The exit surface 112 is an anamorphic surface having different powers in the main scanning direction and the sub-scanning direction.

As shown in FIG. 5, the optical sensor 120 is a sensor for determining a writing position of the light beam B with respect to the photosensitive drum 200, and detects the light beam B that has passed through the window member 110. Specifically, a controller (not shown) determines the writing position of the light beam B on the photosensitive drum 200, based on the timing at which the light beam B is detected by the optical sensor 120.

The laser circuit board 90 is located at the end of the frame F on the other side in the third direction. The laser circuit board 90 is located on the side opposite to the polygon mirror 51 with respect to the coupling lens 20 in the third direction. As shown in FIGS. 2 and 5, the semiconductor lasers 10Y, 10M, 10C, and 10K and the optical sensor 120 are mounted to the laser circuit board 90.

The frame F includes a first wall F1, a second wall F2, a third wall F3, and a fourth wall F4. The first wall F1, the second wall F2, the third wall F3 and the fourth wall F4 form a third recess CP3 in which the optical deflector 50 is accommodated. The third recess CP3 is located at a center of the first recess CP1 in the second direction.

The optical deflector 50 is located between the first wall F1 and the third wall F3 in the second direction. The optical deflector 50 is located between the second wall F2 and the fourth wall F4 in the third direction. The second wall F2 and the fourth wall F4 are connected to the first wall F1 and the third wall F3.

The first wall F1 is a wall that partitions the optical deflector 50 from part of the third scanning optical system LoC and the fourth scanning optical system LoK. Specifically, the first wall F1 partitions the optical deflector 50 from the members of the third scanning optical system LoC and the fourth scanning optical system LoK other than the first scanning lens 60CK.

As shown in FIGS. 5 and 6, the first wall F1 has a first opening H1 and a second opening H2. The first opening H1 is an opening through which the light beam BC, BK directed from the optical deflector 50 to the third scanning optical system LoC or the fourth scanning optical system LoK passes. The second opening H2 is an opening through which the light beam B directed from the optical deflector 50 to the optical sensor 120 passes. The first scanning lens 60CK closes the first opening H1. The window member 110 closes the second opening H2. Specifically, the first scanning lens 60CK (the closest scanning lens to the optical deflector 50 in the scanning optical system Lo) is fixed in the first opening H1 to close the first opening H1, and the window member 110 is fixed in the second opening H2 to close the second opening H2.

As shown in FIG. 5, the second wall F2 has two third openings H31 and H32. The third openings H31 and H32 are openings through which the light beam B directed from the coupling lens 20 to the optical deflector 50 passes. The third openings H31 and H32 are formed in slit shapes elongated in the first direction and penetrate in the third direction. The light beam BY, BM passes through the third opening H31. The light beam BC, BK passes through the third opening H32.

As shown in FIGS. 5 and 6, the third wall F3 has a fourth opening H4. The fourth opening H4 is an opening through which the light beam BY, BM directed from the optical deflector 50 to the first scanning optical system LoY or the second scanning optical system LoM passes. The first scanning lens 60YM closes the fourth opening H4.

The condenser lens 40 closes the third openings H31 and H32. The condenser lens 40 is sandwiched between the second wall F2 and the aperture plate 30.

As shown in FIG. 9, the condenser lens 40 has a rib 40A protruding from the exit surface to one side of the third direction, that is, in the traveling direction of the light beam B incident on the condenser lens 40. The rib 40A is in contact with the second wall F2. The condenser lens 40 also has a rib 40B protruding from the entrance surface to the other side in the third direction. The rib 40B is in contact with the aperture plate 30. Specifically, each end of the rib 40B in the second direction is in contact with the aperture plate 30 (see FIG. 1). The ribs 40A and 40B are configured to surround the periphery of the exit surface and the entrance surface, which are optical surfaces of the condenser lens 40. This allows the condenser lens 40 to close the third openings H31 and H32 without bringing the optical surfaces of the condenser lens 40 into direct contact with the second wall F2 and the aperture plate 30.

As shown in FIG. 8, the scanning optical device 1 further includes a first cover C1 (an example of a deflector cover). The first cover C1 covers the optical deflector 50 from the side opposite to the mount surface Fb11. Specifically, the first cover C1 covers the first recess CP1.

The first cover C1 has two first ribs R11 and R12. Each of the first ribs R11 and R12 overlaps the first wall F1 when viewed from the traveling direction of the light beam B incident on the first scanning lens 60CK (see FIG. 4), more specifically from the second direction. Each of the first ribs R11 and R12 extends in the third direction. The distance between the first wall F1 and each of the first ribs R11 and R12 in the second direction is smaller than the thickness of the first wall F1. The two first ribs R11 and R22 sandwich the first wall F1 in the second direction. Of the two first ribs, the first rib R11 farther from the polygon mirror 51 protrudes further toward the first base wall Fb1 than the first rib R12 which is closer to the polygon mirror 51. The two first ribs R11 and R12 are similarly provided on the third wall F3 on one side of the polygon mirror 51 in the second direction.

As shown in FIG. 4, the scanning optical device 1 further includes two seal members 210 and 220. One seal member 210 is located between the first scanning lens 60CK and the first cover C1. The one seal member 210 closes the first opening H1 together with the first scanning lens 60CK. Further, the one seal member 210 is located between the window member 110 and the first cover C1. The one seal member 210 closes the second opening H2 together with the window member 110. The other seal member 220 is located between the first scanning lens 60YM and the first cover C1. The other seal member 220 closes the fourth opening H4 together with the first scanning lens 60YM. The seal members 210 and 220 are made of an elastic member such as sponge.

As shown in FIG. 9, the scanning optical device 1 further includes a second cover C2 (an example of a coupling-lens cover). The second cover C2 covers the coupling lens 20. Specifically, the second cover C2 covers the second recess CP2.

The second cover C2 includes a second rib R2. The second rib R2 overlaps the second wall F2 when viewed from the traveling direction of the light beam B incident on the condenser lens 40, specifically from the third direction. The distance in the third direction between the second rib R2 and the second wall F2 is smaller than or equal to the thickness of the second wall F2.

As described above, according to this embodiment, the following effects are obtained.

As shown in FIG. 5, the first opening H1 of the first wall F1 is closed by the first scanning lens 60CK, and the second opening H2 is closed by the window member 110. Thus, the first scanning lens 60CK and the window member 110 suppress dust and so on entering around the polygon mirror through the first opening H1 and the second opening H2. Further, since the light beam B directed toward the optical sensor 120 passes through the window member 110 different from the first scanning lens 60CK, it is unnecessary to provide the first scanning lens 60CK with an area for allowing the light beam B directed toward the optical sensor 120 to pass through. This suppresses an increase in the size of the first scanning lens 60CK.

Since the window member 110 is a lens that converges the light beam B onto the optical sensor 120, the number of parts is reduced compared to a structure in which a lens for the optical sensor is provided separately from the window member.

The entrance surface 111 of the window member 110 is perpendicular to the optical path of the light beam B directed from the optical deflector 50 to the optical sensor 120. Thus, compared with a structure in which the entrance surface of the window member is inclined with respect to the optical path, the loss of light quantity is reduced and the size of the second opening H2 is reduced.

As shown in FIG. 8, the first cover C1 includes the first ribs R11 and R12 that overlap the first wall F1 when viewed from the second direction. Thus, the first ribs R11 and R12 suppresses dust and so on entering around the polygon mirror 51 through the gap between the first wall F1 and the first cover C1.

As shown in FIG. 5, the third openings H31 and H32 of the second wall F2 are closed by the condenser lens 40. Thus, the condenser lens 40 suppresses dust and so on entering around the polygon mirror 51 through the third openings H31 and H32.

As shown in FIG. 9, the second cover C2 includes the second rib R2 that overlaps the second wall F2 when viewed from the third direction. Thus, the second rib R2 suppresses dust and so on entering around the polygon mirror 51 though the gap between the second wall F2 and the second cover C2.

By sandwiching the condenser lens 40 between the second wall F2 and the aperture plate 30, the condenser lens 40 is brought into close contact with the second wall F2. This further suppresses dust and so on entering around the polygon mirror 51 through the third openings H31 and H32.

As shown in FIG. 4, the seal member 210, 220 is located between the first scanning lens 60YM, 60CK and the first cover C1. Thus, the seal member 210, 220 suppresses dust and so on entering around the polygon mirror 51 through the gap between the first scanning lens 60YM, 60CK and the first cover C1.

As shown in FIG. 9, the condenser lens 40 includes the ribs 40A that protrude in the third direction and contact the second wall F2. This enables the condenser lens 40 to seal the third openings H31 and H32 without bringing the optical surface of the condenser lens 40 into contact with the second wall F2.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Thus, the disclosure is intended to embrace all known or later developed alternatives, modifications, variations, improvements, and/or substantial equivalents. Some specific examples of potential alternatives, modifications, or variations in the described invention are provided below.

The window member may be a member that simply transmits a light beam and does not have a lens function. In this case, a lens for condensing the light beam on the optical sensor may be provided separately from the window member.

The condenser lens may be integral with the coupling lens.

In the above embodiment, part of the scanning optical system Lo is attached to one side of the first base wall Fb1 in the first direction, but the present disclosure is not limited to this. For example, the entire scanning optical system may be attached to one side of the first base wall in the first direction.

In the above-described embodiment, the frame F has substantially rectangular frame-shaped side walls surrounding each of the recesses CP1 and CP2. At least one of the frame-shaped side walls may be provided at the first cover or the second cover.

The first cover may cover at least a portion of the frame where the optical deflector is arranged. For example, a cover that covers the optical deflector and a cover that covers a part of the scanning optical system may be separate. The cover may cover the entire scanning optical system. For example, in a case where the entire scanning optical system is accommodated in the first recess, the cover may cover the entire scanning optical system.

The number of the first ribs and the second ribs is not limited to the above embodiment, and may be any number. Further, two second ribs may be provided and the second wall may be sandwiched between the two second ribs.

The semiconductor laser 10 may be configured to have a plurality of light emitting points. With this configuration, a plurality of light beams emitted from the semiconductor laser 10 may be converted into a plurality of light beams by one coupling lens 20, and the plurality of light beams may be imaged on the surface of the photosensitive drum 200 by the corresponding scanning optical system Lo. When configured in this manner, each of the light beams BY, BM, BC, and BK of the above embodiment includes a plurality of light beams.

In the above-described embodiment, the scanning optical device applied to a color image forming apparatus is exemplified. However, the scanning optical device may be applied to a monochrome image forming apparatus that scans one light beam.

In the above embodiment, the window member 110 has the flat-shaped entrance surface 111, but the entrance surface 111 may be a surface having power instead of a flat surface. In the above embodiment, the exit surface 112 is an anamorphic surface, but the exit surface may be an axisymmetric surface.

The elements described in the above-described embodiment and modifications may be implemented in any combination.

What is claimed is:

1. A scanning optical device comprising:
a semiconductor laser configured to emit light;
a coupling lens configured to convert the light emitted by the semiconductor laser into a light beam;
an optical deflector including a polygon mirror configured to deflect, in a main scanning direction, the light beam converted by the coupling lens;
a scanning optical system configured to receive the light beam deflected by the optical deflector and to form an image on an image surface;
a window member configured to transmit the light beam deflected by the optical deflector;
an optical sensor configured to detect the light beam that passes through the window member; and
a frame having a mount surface on which the optical deflector is mounted,
the frame including a first wall having a first opening through which the light beam directed from the optical deflector toward the scanning optical system passes and a second opening through which the light beam directed from the optical deflector toward the optical sensor passes,
the first opening being closed by a closest scanning lens to the optical deflector in the scanning optical system,
the second opening being closed by the window member.

2. The scanning optical device according to claim 1, wherein the window member is a lens configured to condense the light beam on the optical sensor.

3. The scanning optical device according to claim 1, wherein the window member has a flat-shaped entrance surface; and
wherein the entrance surface is perpendicular to an optical path of the light beam directed from the optical deflector toward the optical sensor.

4. The scanning optical device according to claim 1, further comprising a deflector cover configured to cover the optical deflector on a side opposite to the mount surface,
wherein the deflector cover includes a rib overlapping the first wall when viewed from a traveling direction of the light beam that is incident on the scanning lens.

5. The scanning optical device according to claim 1, further comprising a condenser lens configured to condense the light beam from the coupling lens in a sub-scanning direction,
wherein the frame includes a second wall having a third opening through which the light beam directed from the coupling lens toward the optical deflector passes; and
wherein the third opening is closed by the condenser lens.

6. The scanning optical device according to claim 5, further comprising a coupling-lens cover configured to cover the coupling lens,
wherein the coupling-lens cover includes a rib overlapping the second wall when viewed from a traveling direction of the light beam that is incident on the condenser lens.

7. The scanning optical device according to claim 5, wherein the frame includes an aperture plate located between the coupling lens and the condenser lens, the aperture plate having a stop aperture through which the light beam passes; and
wherein the condenser lens is sandwiched between the second wall and the aperture plate.

8. The scanning optical device according to claim 5, wherein the condenser lens includes a rib protruding in a traveling direction of the light beam that is incident on the condenser lens, the rib being in contact with the second wall.

9. The scanning optical device according to claim 1, further comprising:
a deflector cover configured to cover the optical deflector on a side opposite to the mount surface; and
a seal member located between the scanning lens and the deflector cover.

10. The scanning optical device according to claim 1, wherein the frame includes:
a first base wall crossing a first direction along a rotation axis of the polygon mirror, the optical deflector being attached to the first base wall; and
a second base wall crossing the first direction, the second base wall being located at a position shifted to one side in the first direction with respect to the first base wall;
wherein the optical deflector is located on the one side in the first direction with respect to the first base wall; and
wherein the coupling lens is located on an other side in the first direction with respect to the second base wall.

11. The scanning optical device according to claim 10, wherein the frame has a first recess and a second recess, the first recess opening on one side in the first direction, the second recess opening on an other side in the first direction,
wherein the polygon mirror is disposed in the first recess; and
wherein the coupling lens is disposed in the second recess.

12. The scanning optical device according to claim 1, wherein the image surface is a circumferential surface of a photosensitive drum provided in an image forming apparatus; and
wherein the optical sensor is for determining a writing position of the light beam with respect to the photosensitive drum.

13. The scanning optical device according to claim 1, further comprising a laser circuit board located on a side opposite to the polygon mirror with respect to the coupling lens in the main scanning direction,
wherein the semiconductor laser and the optical sensor are mounted to the laser circuit board.
